(19) United States
(12) Patent Application Publication
(10) Pub. No.: US 2011/0158370 A1
(43) Pub. Date: Jun. 30, 2011

(54) Offshore energy carrier production plant

(76) Inventor: David B. Morgan, Clinton, UT (US)

(21) Appl. No.: 12/655,281

(22) Filed: Dec. 28, 2009

(51) Int. Cl. G21C 1/00; G21C 7/32; B63B 35/44

(52) U.S. Cl. 376/210; 376/317; 114/264; 405/195.1

(57) ABSTRACT

Disclosed is an offshore fixed, moored, or mobile energy carrier production plant. The plant's energy source for the energy intensive processes of producing an energy carrier is nuclear in nature and the resulting energy carriers of the plant range from hydrogen to hydrocarbons such as methanol and jet fuel. The offshore energy carrier production plant will be able to produce energy carriers at a reduced cost, increased sustainability and scalability, increased safety, and with fewer environmental and social impacts than heretofore possible. The resulting energy carrier products can then be transported by marine vessels, pipelines, and other transportation means or any combination of transportation means thereof to be distributed to end use energy carrier consuming devices and products such as fuel cell applications in a variety of industries as well as internal combustion engines.

### BACKGROUND OF THE INVENTION

1. Field of the Invention

The present invention relates to an offshore fixed, moored, or mobile energy carrier production plant. The plant's energy source for the energy intensive processes of producing an energy carrier is thermal nuclear in nature and the resulting energy carriers of the plant range from hydrogen to hydrocarbons such as methanol and jet fuel. The resulting energy carrier products can then be transported by marine vessels, pipelines, and other transportation means or any combination of transportation means thereof to be distributed to end use energy carrier consuming devices and products such as fuel cell applications in a variety of industries as well as internal combustion engines.

2. Description of the Prior Art

The need for a long-term replacement of fossil fuels, which are naturally existing energy carriers, is an ever increasing need due to the limited supply of fossil fuels as well as the destructive releases of carbon emissions and other harmful elements, molecules, and compounds into the atmosphere that occur as the energy is released by use of fossil fuels. Fossil fuels do provide a reliable and scalable energy solution as long as the fossil fuel resources remain accessible and useable. Carbon sequestration in addition to other environmental mitigations is proving to be costly as well as risky since the true impact of these measures may not be known for decades.

Nuclear energy is able to produce a reliable and scalable energy solution. However, conventional methods of using nuclear energy for peaceful purposes involves land investments in addition to interior water resources for process cooling both of which are needed to sustain human life and are becoming increasingly sparse in supply, especially in habitable U.S. locations. Nuclear proliferation, accident, and terrorist concerns also exist as many nuclear power plants today are located in or near dense population areas which adds complexities to fully protecting nuclear material as well as limiting public exposure to potential incidents and hazards. In addition, interior water resources used and consumed by most nuclear power plants adds to already overburdened interior water supply systems which are needed to sustain human life through both potable water supplies as well as agricultural irrigation water supplies. This range of complex issues calls for a method to produce reliable, sustainable, and scalable energy production without jeopardizing public health and safety.

U.S. Pat. Nos. 3,837,308, 3,962,877, 4,302,291, 5,247,553 each describes offshore above water or underwater power generation facilities producing energy in the form of electrical energy with transmission of electrical energy via cables to the shoreline. The fundamental flaw is the limited method used to distribute the energy. Electrical energy generation via this method is suitable for remote populations without a major electrical grid infrastructure or a temporary form of electrical power needed for energy intensive projects.

U.S. Pat. No. 3,837,309 describes a “floating power plant that is housed in a generally spherical double-walled shell.” Additionally, the “shell and its contents form part of a compound pendulum whose center of mass is located below the metacenter of the sphere and which has a natural frequency substantially below that of the prevailing wave frequency of the water.” This patent, in addition to issues of electrical power transmission to shore, requires a completely revolutionary marine design as well as a revolutionary nuclear power plant design. The complexity of the design is just one possible reason the plant was never built. U.S. Pat. No. 3,962,877 is an “offshore power plant in which the steam generators of the power plant are located within the support structure carrying the components of the power plant.” It further describes, “instead of transporting the produced natural gas to the mainland, to convert it into electric power directly at the well head.” This patent again has the weakness of relying on electrical transmission to shore as well as being restricted to locations which have natural gas as an energy source and does not involve a nuclear power source. It is unknown if this invention was ever produced.

U.S. Pat. No. 4,302,291 describes a “structure for an underwater nuclear power generating plant comprising a triangular platform formed of tubular leg and truss members.” Again, this patent illustrates a completely revolutionary nuclear and marine design both of which create a high level of complexity in addition to the limitation of electrical distribution to shore. Also, the submerged devices would be prone to maintenance access issues for major repairs. U.S. Pat. No. 5,247,553 also describes a “submerged passively-safe power station” and also describes a method to use “spent thermal energy in a multi-stage flash desalination process.” The patent also describes a method to service and provide maintenance which improved upon previous designs, but again was limited to electrical distribution of energy to shore.

The U.S. Army commissioned the Sturgis as the first floating nuclear power plant in the 1960's for this very purpose. It provided the Army with useful niche purpose electrical power generation, however, the concept failed to have broader energy implications as history shows offshore nuclear power plants have failed to provide commercial viability. The World Nuclear News in August 2009 reported Russia will complete in 2011 the country's first floating nuclear power plant, however, the plant is destined for a niche energy area such as providing power to remote regions and energy intensive projects such as oil and gas exploration. While the floating nuclear power plants have the possible advantage of mass production; the broader energy use is quite limited and constrained. R. A. Pfeffer and William A. Macon theoretically described hydrogen production from seawater by using a nuclear reactor for military applications but failed to provide a description for one skilled in the art to construct or build such an invention and only provided a theoretical basis with reference to the U.S. Army's Sturgis project. In addition the paper failed to mention hydrogen storage and distribution issues with possible ways to overcome such issues to make the invention useful beyond a limited scope. The paper also failed to address large scale use in any detail and limited observations to military and other limited purposes.

### SUMMARY OF THE INVENTION

The present invention is an offshore fixed, moored, or mobile energy carrier production plant. The plant's energy source for the energy intensive processes of producing an energy carrier is thermal nuclear in nature and the resulting energy carriers of the plant range from hydrogen to hydrocarbons such as methanol and jet fuel. The present invention includes sophisticated electrical, chemical, and thermal processes to strip hydrogen from water then compress and store hydrogen for distribution and combine hydrogen with carbon from varying sources to form hydrocarbons. The resulting energy carrier products can then be transported by marine vessels, pipelines, and other transportation or any combination of transportation means thereof to be distributed to end use energy carrier consuming devices and products such as fuel cell applications in a variety of industries as well as internal combustion engines.

It is therefore a primary object of this invention to produce hydrogen and hydrocarbons from surrounding water and varying sources of carbon in an offshore sustainable, scalable, and reliable manner which will significantly decrease reliance on fossil fuels as an energy source.

It is another object of this invention to provide an environment in which a mass producible nuclear reactor can be utilized to lower production costs as well as capital costs and dramatically increase the use of carbon free nuclear energy.

It is still another object of this invention to provide a design which can be produced in mass quantities to provide both operational cost efficiency as well as scalability required to meet global energy demands.

It is still another object of this invention to provide a mechanism to permit global energy carrier distribution.

It is still another object of this invention to reduce strained demand of interior water supplies in the energy sector.

It is still another object of this invention to enhance nonproliferation of special nuclear materials.

It is still another object of this invention to produce energy carrier fuels suitable for the transportation industry as well as other industries reliant on fossil fuels and derivatives of fossil fuels.

It is still another object of this invention to dramatically reduce net carbon emissions as fossil fuels are displaced by the products produced by this invention.

These and other objects of the present invention will become apparent to those skilled in this art upon reading the accompanying description, drawings, and claims set forth herein.

### BRIEF DESCRIPTION OF THE DRAWINGS

FIG. 1 is a two-dimensional rendering from the front of the offshore mobile semi-submersible platform energy carrier production plant according to the present invention.

FIG. 2 represents an optional mooring configuration of the offshore semi-submersible platform energy carrier production plant.

FIG. 3 represents an optional fixed platform configuration of the offshore energy carrier production plant.

FIG. 4 represents an optional artificial island configuration of the offshore energy carrier production plant.

FIG. 5 is a three-dimensional view of the offshore mobile semi-submersible platform energy carrier production plant based upon FIG. 1.

FIG. 6 is a cross section view of the offshore mobile semi-submersible platform energy carrier production plant of the present view taken along line 6-6 of FIG. 1.

FIG. 7 is a cross section view of the offshore mobile semi-submersible platform energy carrier production plant of the present view taken along line 7-7 of FIG. 1.

FIG. 8 is a cross section view of the offshore mobile semi-submersible platform energy carrier production plant of the present view taken along line 8-8 of FIG. 1.

### DETAILED DESCRIPTION OF THE INVENTION

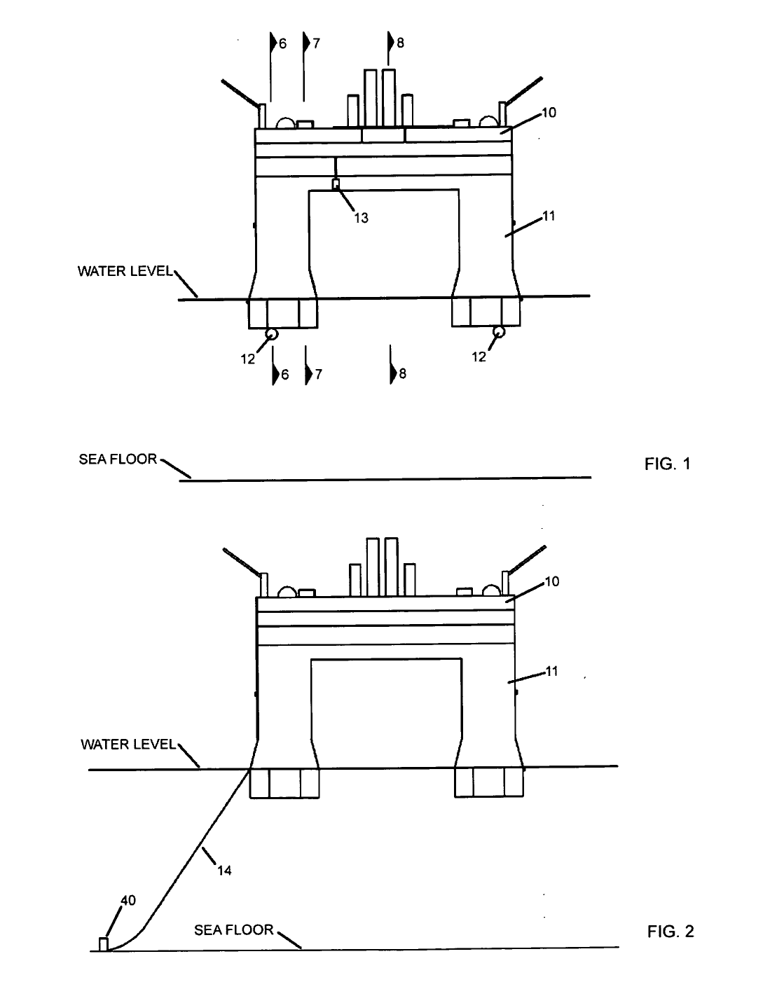

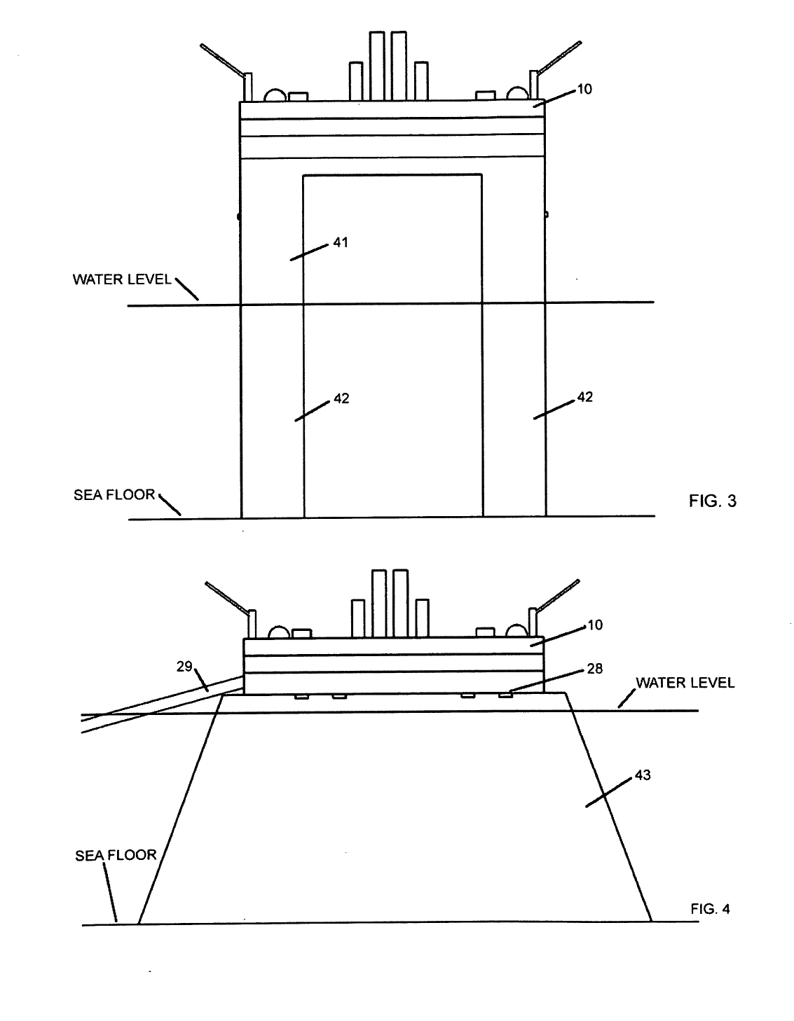

FIG. 1 shows a three-dimensional rendering of the best mode contemplated by the inventor of an offshore mobile energy carrier production plant 10, herein referred to as the plant 10 for brevity, according to the concepts of the present invention. An example of the preferred plant 10 is carried by a semi-submersible bare-deck platform 11 also known as the MOSS CS-50 deep-sea semi-submersible platform which is available from Vyborg Shipyard JSC, 2b Primorskoe Shossee 188800 Vyborg, Russia and provides the option to be equipped with a dynamic positioning system 12 for deep water use or anchorage system 13 for water depths less than 1500 m. The semi-submersible platform 11 is selected as the best mode apparatus due to the significant stability and versatility afforded by such a design, however, other mobile nautical vessels apparatus or platforms may be able to adequately function as an offshore energy carrier production plant. An alternate offshore configuration, which could be considered, includes as depicted in FIG. 2, a mooring system of cables 14 to secure the semisubmersible platform 11 via sea floor anchors 40 to provide stability for the plant 10. A further offshore configuration is depicted in FIG. 3 with support columns 42 extending and secured to the water body floor from a fixed platform 41 to carry plant 10. An even further offshore alternative is an artificial island configuration as shown in FIG. 4 with an earth like material base 43 extending to the water body floor to carry plant 10. Additionally a plurality of offshore methods described previously of carrying the plant equipment could be utilized.

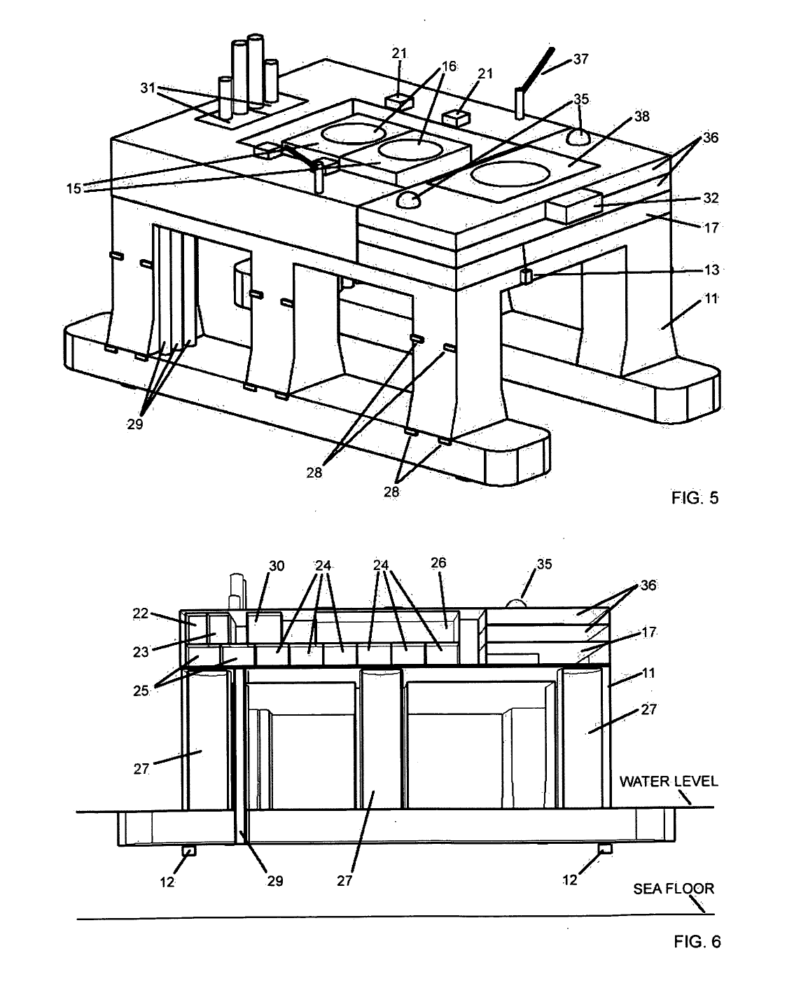

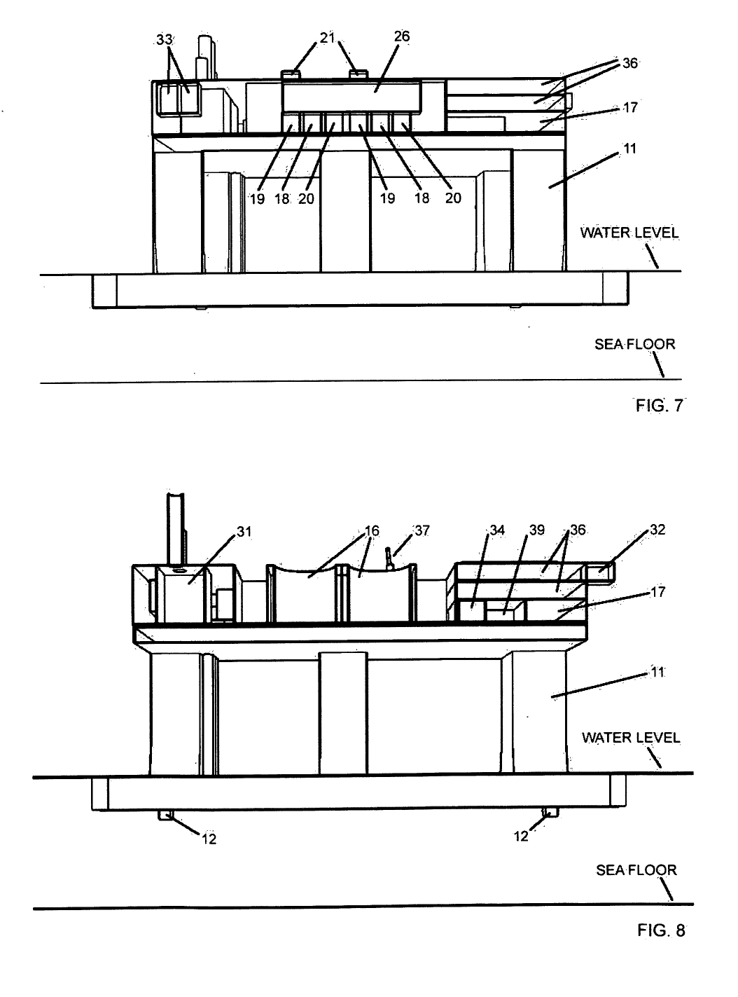

As depicted in FIG. 5 through FIG. 8 various sections are shown to provide the totality of components required for processes and is the best mode contemplated by the inventor based upon FIG. 1. FIG. 6 through FIG. 8 are indicative of a mirror image of the opposite side, thus these components exist in duplicate but are not shown to minimize the number of figures. At the center of the plant 10 are two reactor vessel containment structures 15 which each house approximately a 300 MWe nuclear reactor vessel 16. An example of the preferred reactor vessel 16 is a modified A1B Aircraft Carrier Naval reactor which is currently in the final design phases by Bechtel of San Francisco, Calif. It is anticipated that the center of the semi-submersible platform 11 and center of plant 10 is the ideal location of the reactor vessel containment structures 15 as this provides the greatest protection from a collision with a vessel of comparable size thus minimizing the potential of a nuclear disaster as well as potentially minimizing the level of impact the reactor vessels 16 and containment structures 15 would be required to withstand. Alternative configurations for reactor vessel 16 and containment structure 15 not depicted include nuclear fission designs for water cooled, gas cooled, or liquid metal cooled reactors. Additionally a series of smaller reactors coupled together could accomplish the same energy requirements necessary to optimize energy demands of plant 10 processes as well as provide optimization of overall weight and size of components. Considering all existing and future technologies of all nuclear sources whether it be fission or fusion that are capable of significant thermal energy generation is justified as a potential energy source. Spent nuclear fuel could be placed in a secure storage area 17. Storage area 17 could be built large enough to contain perhaps decades of spent fuel until said plant 10 is decommissioned at which time spent fuel could be safely and securely relocated to another secure area on a nearby plant 10 or safely transported to an accessible long term storage facility or reprocessing facility.

Thermal energy produced via the nuclear reactor vessels 16 will be extracted via heat exchangers 18 from an appropriate primary reactor cooling loop. Thermal energy will then be distributed via appropriate piping to fulfill a variety of purposes described and depicted herein. Thermal energy not utilized by processes will be transferred out of the system via condensers 19 which can be cooled via sea water pumped by pumps 20 or air cooled via fans 21 or a combination thereof. Thermal energy will be utilized to produce steam to turn turbines 22 with appropriately mated generators 23 for the production of electricity.

Thermal energy as well as electrical energy will be used to perform high temperature steam electrolysis in solid oxide cells 24 to produce hydrogen, oxygen, syngas or any combination thereof. The source of hydrogen and oxygen is expected to be derived from water surrounding plant 10. While not yet commercially available, an example of this process using solid oxide cells can be found in United States Patent Application 20080023338 by Battelle Energy Alliance, LLC, Idaho Falls, ID. The resulting hydrogen, oxygen, and syngas from this process would be used in additional processes described herein as well as serve as sellable commodities by compressing using compressors 25 and storing in storage tanks 27 for later distribution via marine vessels utilizing dock 28 or pipeline 29 distribution. Ultimately, liquid hydrocarbons would be much easier to transport from the production locations than would hydrogen, thus the need for a source of carbon. The pipelines 29 can transport various liquids or gases to and from the plant 10 to other nearby plants 10, the surrounding water for process water and thermal energy exchange, or the shore.

Boiler feed grade water required by hydrogen, oxygen, and syngas production processes as well as for other processes and human consumption would be produced by pumping surround water using pumps 20 into desalination units 30 utilizing preferably waste thermal energy or prime thermal energy if demand requires. An example of possible desalination units 30 is the IDE LT-MED Process for Combined Power Generation and Seawater Desalination available from IDE Technologies Ltd, Hamatechet St., Hasharon Industrial Park, P.O. Box 5016, Kadima 60920, Israel.

The carbon source required for the syngas process could be captured from the atmosphere using known methods and processes such as using potassium carbonate and electrolytic stripping in carbon capture process facility 26 which could use airflow from condenser fans 21 for atmospheric carbon capture. Resulting potassium based salts could be evaluated for environmental impact of disposal directly into a salt water body or could be sold as a useful byproduct. This process can be found in “Green Freedom: A Concept for Producing Carbon-Neutral Synthetic Fuels and Chemicals” released by the Los Alamos National Laboratory in July 2006. Additionally, carbon could be derived from a variety of sources such as industrial waste carbon dioxide capture followed by transport by marine vessels or pipelines 29 in compressed gas or liquid form. Additionally, the U.S. Navy recently performed a successful extraction of carbon dioxide from sea water which is reported to have 140 times the concentration of carbon dioxide than that of the atmosphere. Details of this process can be found in the proceedings of the 238^{th} ACS National Meeting, “Catalytic CO2 hydrogenation to feedstock chemicals for jet fuel synthesis.” Other known methods could be pursued as well with the consideration of the need to transport raw catalytic and reagent materials as well as byproduct materials to and from the production locations.

It is anticipated that compressed or liquefied syngas or hydrogen could be subject to high transportation costs as well as transportation risks; therefore, it may be preferable to convert syngas into liquid hydrocarbon energy carriers (fuels) via a Fischer-Tropsch process technology plant 31 onsite. Syntroleum Corporation at 5416 S. Yale Ave., Tulsa, Okla., is an example of a commercial provider of such technology. Resulting liquid fuels combined with desired additives would be held in storage tanks 27 transported via pipelines 29 or marine vessels for end use consumption.

While high temperature steam electrolysis is the preferred method due to near commercial readiness and efficient method to produce hydrogen as well as syngas for conversion to liquid energy carriers via the Fischer-Tropsch process, it should be appreciated by those skilled in the art that there are other methods to yield hydrogen production with the same or similar results to include but not limited to: various methods of electrolysis; thermo chemical processes such as the sulfur-iodine cycle, cerium (IV) oxide-cerium (III) oxide cycle, copper-chlorine cycle, iron oxide cycle, zinc zinc-oxide cycle or similar thermo chemical cycle, or thermo chemical electrolysis combined cycle process facility such as the hybrid sulfur cycle using combined high temperature electrolysis or similar thermo chemical hybrid combined electrolysis method.

While using the Fischer-Tropsch process to yield liquid hydrocarbons is the preferred method due to commercial scale operational viability, it should be appreciated by those skilled in the art that there are other non-traditional methods in development to yield the same or similar results such as metabolic engineering of organisms and synthetic biological approaches for the conversion of carbon dioxide and hydrogen to liquid fuels using electrical energy, thermal energy, or combination thereof. The Los Alamos National Laboratory paper referenced previously uses a method for methanol synthesis and the Exxon Mobil MTG process which could also serve as a viable alternative.

The semi-submersible platform 11 could be equipped with a fully functioning navigation system 32 and using the dynamic positioning system 12 to permit the semi-submersible platform 11 full maneuverability. Many routine procedures such as reactor vessel 16 refueling can take place at sea. Multiple reactor vessels 16 are suggested to provide a continual nuclear thermal energy source for continued operation should one reactor require maintenance. Semi-submersible platform 11 mobility may be needed to safely maneuver the plant 10 away from both environment and terrorist threats such as severe sea conditions or an attempted hostile takeover from an approaching vessel. It is anticipated that from time to time plant 10 and semi-submersible platform 11 would be required to have major maintenance or upgrades performed at sea ports. To avoid complications or concerns arising of a nuclear incident while near population centers at sea ports, the nuclear reactor vessels 16 could be shut down prior to arriving at sea ports. Auxiliary power to critical systems such as navigation and mobility systems could be provided via auxiliary generators 33 fueled by energy in storage tanks 27. Additionally, supplemental power could be provided by the utilization of solid oxide electrolytic cells 24 as solid oxide fuel cells by reversing the process which could be fueled by energy in storage tanks 27.

While a central control, monitoring, and automation system 34 will be used to optimize plant 10 and could be controlled and monitored remotely via a secure communications uplink 35, it is likely that onboard human occupation will be required for both practicality and regulatory purposes. Thus, the plant 10 could contain a habitation area 36 to provide all of the modern necessities as well as some luxuries to accommodate an onboard crew which may be necessary to provide operational and maintenance support. Reactor control area 39 will be designed to meet regulatory requirements. In addition, the plant 10 could contain cranes 37 and well as an aerial transport pad 38 to assist in the movement of goods, materials, and personnel to and from the plant 10. It would be preferred to have the production of hydrogen, syngas, and liquid fuels occur on the same plant 10, however, due to plant 10 weight limitations subject to semi-submersible platform 11 capacity, it may be necessary to have various processes take place at other plants 10 with transfer of various liquids and gasses via pipelines 29 between plants 10 such that a series of plants 10 are capable of providing the desired results.

Physical location placement of the plant 10 is critical when considering design requirements. The plant 10 which operates in areas prone to fewer natural disasters such as hurricanes or typhoons may be able to be designed in a more cost effective manner. To address security concerns, vast areas of sea or ocean could be designated as plant 10 operation areas with the creation of international no fly zones for aircraft larger than the aircraft intended to be utilized by the aerial transport pad to minimize the impact design requirements of the reactor vessel 16 and the reactor containment structures 15 while utilizing national defense systems to warn or take action against unauthorized aircraft approaching no fly zones.

The nature of the plant 10 and the ability for the plant 10 to operate in remote areas potentially up to two hundred miles away from the nearest coastline (the limitation of territorial waters) would make accessibility extremely difficult at best, thus proliferation resistance is inherent. If operated in international waters, the distance could be even greater. In addition, monitoring and tracking unauthorized movement within meters of the plant 10 will be possible unlike land based nuclear power plants which have residential and commercial districts adjacent to plant property as well as in the case of Three Mile Island a commercial runway within a few thousand meters and in the direct takeoff and landing path of large aircraft. With a consistent design it could be possible to mass produce plants 10 with many plants 10 operating in the same secured designated area; thus lowering capital and operational costs. Also, with the ability to ship liquid and gas energy carriers worldwide via marine vessels, the usefulness of the products produced could have a significant global impact.

Depending on the source of carbon for processes and the ability to recapture the carbon on the consumption side, the plant 10 has the potential to actually reduce levels of atmospheric carbon-dioxide and at the very least remain a carbon neutral energy carrier producer.

It is anticipated that the present invention would be of significant interest to the military as the U.S. Department of Defense is the largest national consumer of liquid transportation fuels. Partnering of private industry with the Department of Defense, Department of Energy, as well as other U.S. federal agencies would be advantageous as much of the risk of producing a first of its kind could be removed and lay a solid foundation for the potential to produce many plants 10 to service energy carrier needs worldwide thus potentially enabling the U.S to dominate world energy markets leading into the 22^{nd} century. It is also noteworthy that hydrogen as well as hydrocarbons which are defined herein as energy carriers are used in a broad array of chemical industry applications such as fertilizer, lubricants, polymers, and waxes to name but a few. Therefore, the inventor's term “energy carrier” used herein in no way intends to limit the products produced to strictly the energy field but to also encompass the entire chemical industry for which hydrogen and hydrocarbons are useful.

While each of the core technologies discussed herein are not novel and exist as prior art, it will be appreciated by those skilled in their respective art that the combination of such technologies yields unexpected results including but not limited to increased nuclear proliferation resistance, ability to scale to meet global demands via ease of distribution, reduction in manufacturing costs, and inherent safety and security features. Thus it will be appreciated by those skilled in the art that the invention described herein provides benefit beyond that derived from any separate or sequential operation of the referenced prior art.

Thus it will be appreciated by those skilled in the art that the present invention is not restricted to the particular preferred embodiments described with reference to the drawings, and that variations may be made therein without departing from the scope of the present invention as defined in the appended claims and equivalents thereof.

1. An offshore energy carrier production plant comprising: a thermal energy generating nuclear facility; an energy carrier production facility using energy derived from said thermal energy generating nuclear facility wherein the said energy carrier has the commonality of the element of hydrogen derived in part from water; and an offshore apparatus for carrying the plant components of said offshore energy carrier production plant.

2. An offshore energy carrier production plant according to claim 1, wherein said thermal energy generating nuclear facility is based upon nuclear fission.

3. An offshore energy carrier production plant according to claim 2, wherein said nuclear fission is based upon water cooled reactor technology.

4. An offshore energy carrier production plant according to claim 2, wherein said nuclear fission is based upon gas cooled reactor technology.

5. An offshore energy carrier production plant according to claim 2, wherein said nuclear fission is based upon liquid metal cooled reactor technology.

6. An offshore energy carrier production plant according to claim 1, wherein the said thermal energy generating nuclear facility has a means for converting thermal energy into electrical energy.

7. An offshore energy carrier production plant according to claim 6, wherein the said thermal energy generating nuclear facility and electrical energy are utilized in plant processes.

8. An offshore energy carrier production plant according to claim 7, wherein said processes have a means for producing fresh water derived from surrounding water for processes which require fresh water.

9. An offshore energy carrier production plant according to claim 7, wherein said processes have a means for producing hydrogen based energy carriers.

10. An offshore energy carrier production plant according to claim 9, wherein said hydrogen based energy carrier production has a means for producing hydrogen and oxygen from water.

11. An offshore energy carrier production plant according to claim 9, wherein said hydrogen based energy carrier production has a means for producing hydrocarbons from a source of desired additives, carbon, and hydrogen.

12. An offshore energy carrier production plant according to claim 1, wherein said thermal energy generating nuclear facility is based upon nuclear fusion.

13. An offshore energy carrier production plant according to claim 1, wherein said means for carrying the plant components is fixed.

14. An offshore energy carrier production plant according to claim 13, wherein said fixed means is an artificially created island.

15. An offshore energy carrier production plant according to claim 13, wherein said fixed means is a fixed offshore platform.

16. An offshore energy carrier production plant according to claim 1, wherein said means for carrying the plant components is a moored floating offshore platform.

17. An offshore energy carrier production plant according to claim 1, wherein said means for carrying the plant components is a mobile offshore apparatus.

18. An offshore energy carrier production plant according to claim 17, wherein said mobile offshore apparatus is a mobile offshore nautical vessel.

19. An offshore energy carrier production plant according to claim 17, where said mobile offshore apparatus is a mobile offshore semi-submersible platform.

20. An offshore energy carrier production plant comprising: a thermal energy generating nuclear facility; an energy carrier production facility using energy derived from said thermal energy generating nuclear facility wherein the said energy carrier has the commonality of the element of hydrogen derived in part from water; and an offshore plurality of apparatus for carrying the plant components of said offshore energy carrier production plant wherein the plant design is modularized such that each specialized function is a module or series of modules to be installed on the apparatus.
